(19) United States
(12) Patent Application Publication
(10) Pub. No.: US 2005/0012751 A1
(43) Pub. Date: Jan. 20, 2005

(54) Systems and methods for efficiently updating complex graphics in a computer system by by-passing the graphical processing unit and rendering graphics in main memory

(76) Inventor: Donald David Karlov, North Bend, WA (US)

Correspondence Address: WOODCOCK WASHBURN LLP, ONE LIBERTY PLACE - 46TH FLOOR, PHILADELPHIA, PA, 19103, US

(21) Appl. No.: 10/622,597

(22) Filed: Jul. 18, 2003

(51) Int. Cl. G06F 13/00

(52) U.S. Cl. 345/538

(57) ABSTRACT

In one embodiment of the present invention, a method for rendering complex graphics —comprising “orientation-change graphics” for display on display devices in alternate orientations (e.g., portrait or inverse landscape); compositing of overlays; shading; texturing; anti-aliasing: alpha-blending; and/or sub-pixel manipulation technologies—is disclosed wherein the graphical processing unit (GPU) and video RAM shadow memory (VRAMSM) are bypassed and graphics are rendered in video shadow memory (VSM) by the central processing unit (CPU) and copied directly to the frame buffer. This method avoids the data flow problems of computer systems favoring system-to-video flow of data (that is, systems using an accelerated graphics port (AGP)) and leverages modern CPUs' increased computational speeds wherein the burden of rendering graphics in the CPU is no longer a significant resource cost such that the gains in graphics rendering more than offset any such CPU processing cost.

### CROSS-REFERENCE TO RELATED APPLICATIONS

This application is related by subject matter to the inventions disclosed in the following commonly assigned applications: U.S. patent application Ser. No. ______ (Atty. Docket No. MSFT-1786), filed on even date herewith, entitled “SYSTEMS AND METHODS FOR UPDATING A FRAME BUFFER BASED ON ARBITRARY GRAPHICS CALLS”; and U.S. patent application Ser. No. ______ (not yet assigned) (Atty. Docket No. MSFT-1787), filed on even date herewith, entitled “SYSTEMS AND METHODS FOR EFFICIENTLY DISPLAYING GRAPHICS ON A DISPLAY DEVICE REGARDLESS OF PHYSICAL ORIENTATION”.

### FIELD OF THE INVENTION

The present invention relates generally to the field of computer graphics, and more particularly to utilization of the central processing unit (CPU) and main system random access memory (RAM) in lieu of a graphical processing unit (GPU) and video random access memory (VRAM) to efficiently generate and update computer graphics in a computer frame buffer for display on a display device.

### BACKGROUND OF THE INVENTION

To render certain complex images, it is often necessary for the graphics to be rendered by the CPU in RAM instead of by the GPU in VRAM. To do so, the frame buffer—or its logical equivalent in the VRAM, the VRAM shadow memory (VRAMSM)—must be copied from the graphics card to RAM for processing by the CPU and then copied back from RAM to VRAM. However, because AGP favors a system-to-video flow of data traffic, copying graphics from VRAM to system memory is time consuming and resource intensive, and thereby effectively negates any gains from utilizing the GPU on the graphics card.

What is missing in the art is a resource-efficient approach to rendering and updating complex graphics on a display device. The present invention addresses these shortcomings.

### SUMMARY OF THE INVENTION

In one embodiment of the present invention, a method for rendering complex graphics—including but not limited to “orientation-change graphics” for display on display devices in alternate orientations (left-portrait, right-portrait, or inverse landscape); compositing of overlays such as pop-ups, menus, and cursors; shading; texturing; anti-aliasing: alpha-blending; and/or sub-pixel manipulation technologies such as, for example, ClearType™—is disclosed wherein the GPU and VRAMSM are bypassed and graphics are rendered in VSM by the CPU and copied directly to the frame buffer. This method not only avoids the data flow problems inherent to computer systems that favor system-to-video flow of data traffic (that is, computer systems that utilize an AGP), but it also takes advantage of modern CPUs having increased computational speeds (that are orders-of-magnitude greater than the speeds of legacy processors) such that the burden of rendering graphics in the CPU is no longer a significant resource cost and the gains in graphics rendering more than offset any such CPU processing cost.

### BRIEF DESCRIPTION OF THE DRAWINGS

The foregoing summary, as well as the following detailed description of preferred embodiments, is better understood when read in conjunction with the appended drawings. For the purpose of illustrating the invention, there is shown in the drawings exemplary constructions of the invention; however, the invention is not limited to the specific methods and instrumentalities disclosed. In the drawings:

FIG. 1 is a block diagram representing a computer system in which aspects of the present invention may be incorporated;

FIG. 2A is a block diagram illustrating a computer subsystem where graphics are rendered by the central processing unit (CPU) in main memory (RAM);

FIG. 2B is a block diagram illustrating a computer subsystem where graphics are rendered by a specialized graphical processing unit (GPU) in video memory (VRAM);

FIG. 2C is a block diagram illustrating the computer subsystems shown in both FIG. 2A and FIG. 2B coexisting on the same computer system;

FIG. 3 is a flowchart illustrating the approach by which simple (non-complex) graphics are rendered by the GPU and complex graphics are rendered by the CPU; and

FIG. 4 is a flowchart illustrating the method in one embodiment of the present invention by which all graphics are rendered in system memory by the CPU and copied directly to the frame buffer.

### DETAILED DESCRIPTION OF ILLUSTRATIVE EMBODIMENTS

The subject matter is described with specificity to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the term “step” may be used herein to connote different elements of methods employed, the term should not be interpreted as implying any particular order among or between various steps herein disclosed unless and except when the order of individual steps is explicitly described.

Computer Environment

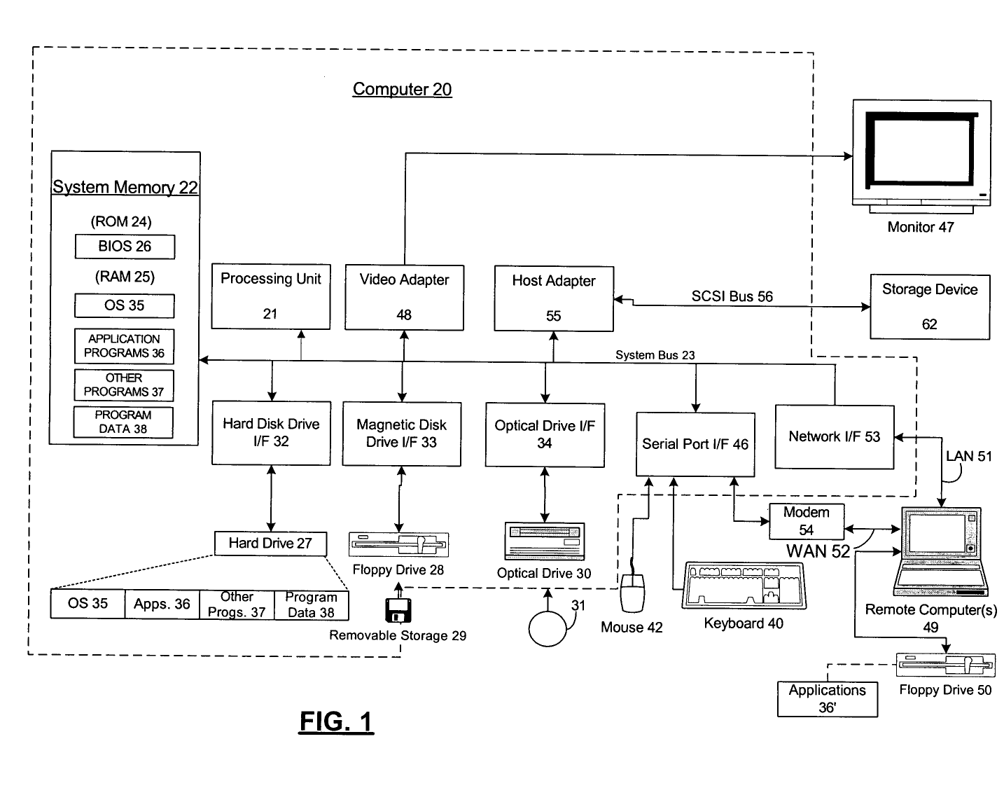

Numerous embodiments of the present invention may execute on a computer. FIG. 1 and the following discussion is intended to provide a brief general description of a suitable computing environment in which the invention may be implemented. Although not required, the invention will be described in the general context of computer executable instructions, such as program modules, being executed by a computer, such as a client workstation or a server. Generally, program modules include routines, programs, objects, components, data structures and the like that perform particular tasks or implement particular abstract data types. Moreover, those skilled in the art will appreciate that the invention may be practiced with other computer system configurations, including hand held devices, multi processor systems, microprocessor based or programmable consumer electronics, network PCs, minicomputers, mainframe computers and the like. The invention may also be practiced in distributed computing environments where tasks are performed by remote processing devices that are linked through a communications network. In a distributed computing environment, program modules may be located in both local and remote memory storage devices.

As shown in FIG. 1, an exemplary general purpose computing system includes a conventional personal computer 20 or the like, including a processing unit 21, a system memory 22, and a system bus 23 that couples various system components including the system memory to the processing unit 21. The system bus 23 may be any of several types of bus structures including a memory bus or memory controller, a peripheral bus, and a local bus using any of a variety of bus architectures. The system memory includes read only memory (ROM) 24 and random access memory (RAM) 25. A basic input/output system 26 (BIOS), containing the basic routines that help to transfer information between elements within the personal computer 20, such as during start up, is stored in ROM 24. The personal computer 20 may further include a hard disk drive 27 for reading from and writing to a hard disk, not shown, a magnetic disk drive 28 for reading from or writing to a removable magnetic disk 29, and an optical disk drive 30 for reading from or writing to a removable optical disk 31 such as a CD ROM or other optical media. The hard disk drive 27, magnetic disk drive 28, and optical disk drive 30 are connected to the system bus 23 by a hard disk drive interface 32, a magnetic disk drive interface 33, and an optical drive interface 34, respectively. The drives and their associated computer readable media provide non volatile storage of computer readable instructions, data structures, program modules and other data for the personal computer 20. Although the exemplary environment described herein employs a hard disk, a removable magnetic disk 29 and a removable optical disk 31, it should be appreciated by those skilled in the art that other types of computer readable media which can store data that is accessible by a computer, such as magnetic cassettes, flash memory cards, digital video disks, Bernoulli cartridges, random access memories (RAMs), read only memories (ROMs) and the like may also be used in the exemplary operating environment.

A number of program modules may be stored on the hard disk, magnetic disk 29, optical disk 31, ROM 24 or RAM 25, including an operating system 35, one or more application programs 36, other program modules 37 and program data 38. A user may enter commands and information into the personal computer 20 through input devices such as a keyboard 40 and pointing device 42. Other input devices (not shown) may include a microphone, joystick, game pad, satellite disk, scanner or the like. These and other input devices are often connected to the processing unit 21 through a serial port interface 46 that is coupled to the system bus, but may be connected by other interfaces, such as a parallel port, game port or universal serial bus (USB). A monitor 47 or other type of display device is also connected to the system bus 23 via an interface, such as a video adapter 48. In addition to the monitor 47, personal computers typically include other peripheral output devices (not shown), such as speakers and printers. The exemplary system of FIG. 1 also includes a host adapter 55, Small Computer System Interface (SCSI) bus 56, and an external storage device 62 connected to the SCSI bus 56.

The personal computer 20 may operate in a networked environment using logical connections to one or more remote computers, such as a remote computer 49. The remote computer 49 may be another personal computer, a server, a router, a network PC, a peer device or other common network node, and typically includes many or all of the elements described above relative to the personal computer 20, although only a memory storage device 50 has been illustrated in FIG. 1. The logical connections depicted in FIG. 1 include a local area network (LAN) 51 and a wide area network (WAN) 52. Such networking environments are commonplace in offices, enterprise wide computer networks, intranets and the Internet.

When used in a LAN networking environment, the personal computer 20 is connected to the LAN 51 through a network interface or adapter 53. When used in a WAN networking environment, the personal computer 20 typically includes a modem 54 or other means for establishing communications over the wide area network 52, such as the Internet. The modem 54, which may be internal or external, is connected to the system bus 23 via the serial port interface 46. In a networked environment, program modules depicted relative to the personal computer 20, or portions thereof, may be stored in the remote memory storage device. It will be appreciated that the network connections shown are exemplary and other means of establishing a communications link between the computers may be used.

While it is envisioned that numerous embodiments of the present invention are particularly well-suited for computerized systems, nothing in this document is intended to limit the invention to such embodiments. On the contrary, as used herein the term “computer system” is intended to encompass any and all devices capable of storing and processing information and/or capable of using the stored information to control the behavior or execution of the device itself, regardless of whether such devices are electronic, mechanical, logical, or virtual in nature.

Graphics Processing Subsystems

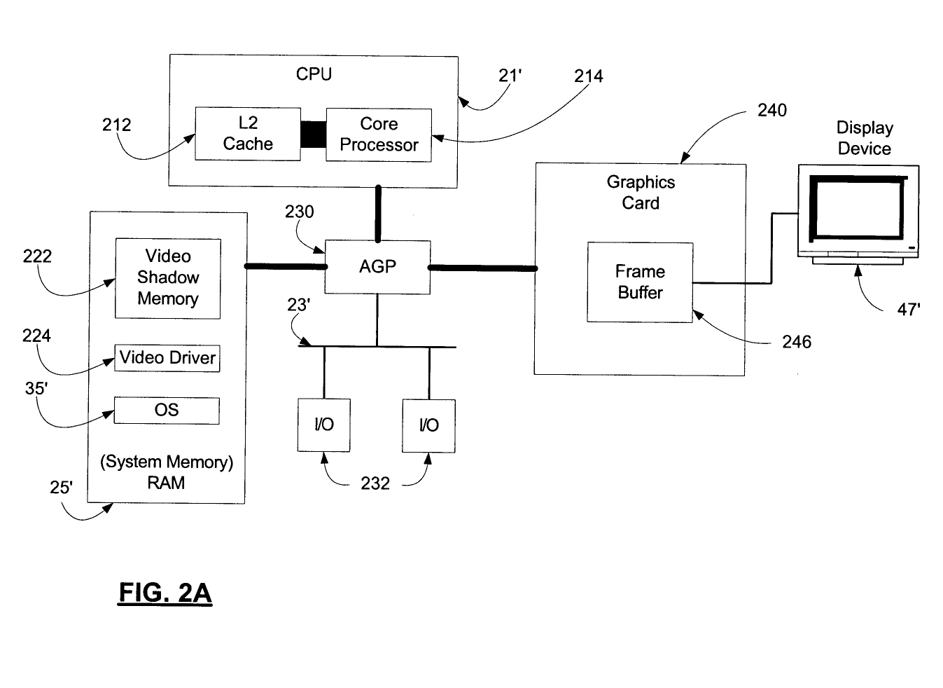

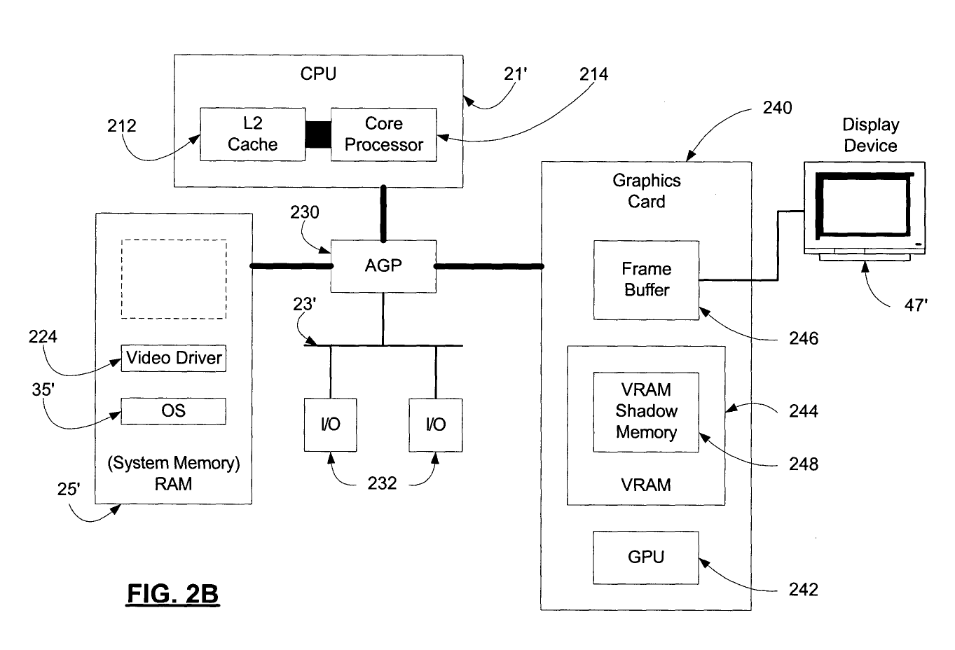

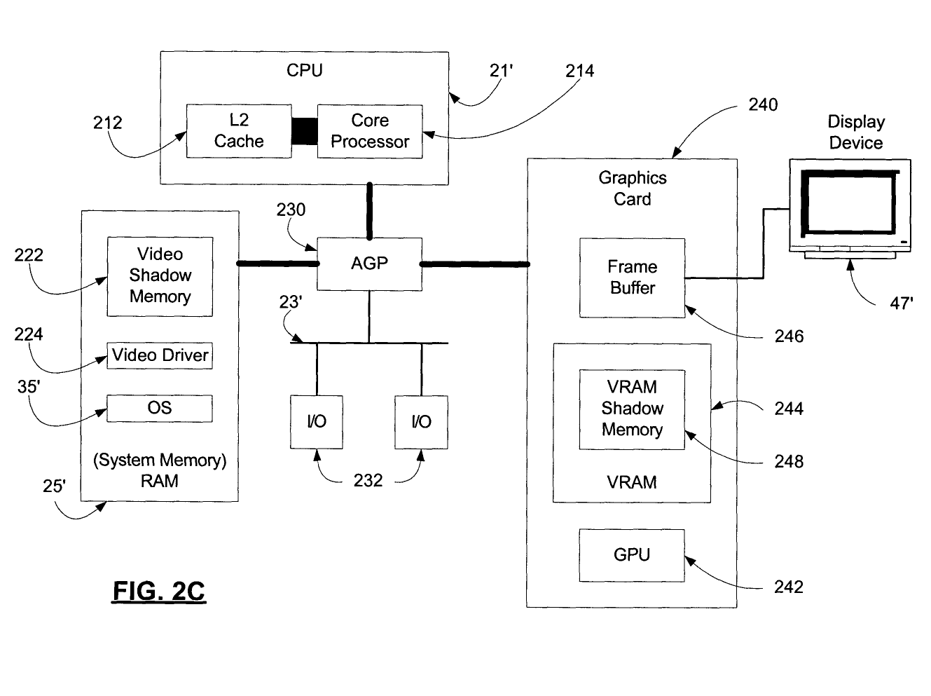

FIGS. 2A, 2B, and 2C are block diagrams illustrating the various elements of three general computer system that comprise typical graphics processing subsystems with which various embodiments of the present invention may be utilized. FIG. 2A illustrates a legacy computer subsystem where graphics are rendered by the central processing unit (CPU) in main memory. FIG. 2B illustrates a current computer subsystem where graphics are rendered by a specialized graphical processing unit (GPU) in video memory. FIG. 2C illustrates the computer subsystem of the present invention that mergers the systems illustrated in FIGS. 2A and 2B to coexist on the same computer system.

In each system, a graphics processing subsystem comprises a central processing unit 21′ that, in turn, comprises a core processor 214 having an on-chip L1 cache (not shown) and is further directly connected to an L2 cache 212. As well-known and appreciated by those of skill in the art, the CPU 21′ accessing data and instructions in cache memory is much more efficient than having to access data and instructions in random access memory (RAM 25, referring to FIG. 1). The L1 cache is usually built onto the microprocessor chip itself, e.g., the Intel MMX microprocessor comes with a 32 KB L1 cache. The L2 cache 212, on the other hand, is usually on a separate chip (or possibly on an expansion card) but can still be accessed more quickly than RAM, and is usually larger than the L1 cache, e.g., one megabyte is a common size for a L2 cache.

For each system in these examples, and in contrast to the typical system illustrated in FIG. 1, the CPU 21′ herein is then connected to an accelerated graphics port (AGP)
230. The AGP provides a point-to-point connection between the CPU 21′, the system memory RAM 25′, and graphics card 240, and further connects these three components to other input/output (I/O) devices 232—such as a hard disk drive 32, magnetic disk drive 34, network 53, and/or peripheral devices illustrated in FIG. 1—via a traditional system bus such as a PCI bus 23′. The presence of AGP also denotes that the computer system favors a system-to-video flow of data traffic—that is, that more traffic will flow from the CPU 21′ and its system memory RAM 25′ to the graphics card 240 than vice versa—because AGP is typically designed to up to four times as much data to flow to the graphics card 240 than back from the graphics card 240.

Also common to FIGS. 2A, 2B, and 2C is the frame buffer 246 (on the graphics card 240) which is directly connected to the display device 47′. As well-known and appreciated by those of skill in the art, the frame buffer is typically dual-ported memory that allows a processor (the GPU 242 in FIG. 2B or the CPU '21 in FIG. 2A, as the case may be) to write a new (or revised) image to the frame buffer while the display device 47′ is simultaneously reading from the frame buffer to refresh the current display content. However, unlike a CPU, a GPU generally does not have any cache memory.

In the subsystem of FIG. 2A (and as further reflected in FIG. 2C), the system memory RAM 25′ may comprise the operating system 35′, a video driver 224, and video shadow memory (VSM) 222. The VSM, which is a mirror image of the frame buffer 246 on the graphics card 240, is the location in RAM 25′ where the CPU 21′ constructs graphic images and revisions to current graphics, and from where the CPU 21′ copies graphic images to the frame buffer 246 of the graphics card 240 via the AGP 230. Using this subsystem, certain embodiments of the present invention may be directly executed by the CPU 21′ and the RAM 25′.

In the subsystem of FIG. 2B (and as further reflected in FIG. 2C), the graphics card 240 may comprise a graphics processing unit (GPU) 242, video random access memory (VRAM) 244, and the frame buffer 246. The VRAM 244 further comprises a VRAM shadow memory (VRAMSM) 248. The GPU 242 and VRAMSM 248 essentially mirror the functionality of the CPU 21′ and the VSM 222 of FIG. 2A for the specific purposes of rendering video. By offloading this functionality to the graphics card 240, the CPU 21′ and VSM 222 are freed from these tasks. For this reason, certain embodiments of the present invention may be directly executed by the components of the graphics card 240 as herein described.

Again, FIG. 2C shows both of the subsystems of FIGS. 2A and 2B co-existing within a single computer system where the computer system itself ostensibly has the ability to utilize either subsystem to execute corresponding embodiments of the present invention, as discussed in more detail herein below.

Graphics Processing Subsystems

As illustrated in FIG. 2A, the most basic graphics cards comprises a frame buffer—no GPU and/or any additional VRAM—and the computer system's CPU directly updates the frame buffer from the VSM. However, the historical shortcoming of such basic cards has been that, for complex graphics operations, the slow legacy CPUs ended up spending a significant portion of their computing time updating video memory to the detriment of processing other applications. For example, for a 3-D graphical image comprises 10,000 polygons, these CPUs would be tasked to draw and fill each polygon in the video memory pixel by pixel. For slow legacy processors, this had a significant impact on processing resources.

The predominant solution to this problem to date has been to develop advanced graphics cards, as illustrated in FIG. 2B, that take some or all of this load off the CPU by incorporating into the graphics card itself a dedicated graphical processing unit (GPU) that is essentially a second processing unit that has been specifically optimized for graphics operations. Additional memory (VRAM) is also usually included for the GPU to enable it to maintain its own shadow memory (VRAMSM) close at hand for speedy memory calls. (Note that with the introduction of this GPU and VRAM, the VSM in system memory is longer required.)

Depending on the graphics card, this GPU may be either a graphics coprocessor or a graphics accelerator. When the graphics card is a graphics coprocessor, the video driver sends graphics-related tasks directly to the graphics coprocessor for execution, and the graphics coprocessor alone render graphics for the frame buffer (without direct involvement of the CPU). On the other hand, when a graphics cards is a graphics accelerator, the video driver sends graphics-related tasks to the CPU and the CPU then directs the graphics accelerator to perform specific graphics-intensive tasks. For example, the CPU might direct the graphics accelerator to draw a polygon with defined vertices, and the graphics accelerator would then execute the tasks of writing the pixels of the polygon into video memory (VRAMSM) and, from there, copy the updated graphic to the frame buffer.

Over time, more and more “complex graphics” operations have come into use, including but not limited to “orientation-change graphics” for display on display devices in alternate orientations (left-portrait, right-portrait, or inverse landscape); compositing of overlays such as pop-ups, menus, and cursors; shading; texturing; anti-aliasing: alpha-blending; and/or sub-pixel manipulation technologies such as, for example, ClearType™, as well as any other graphical processing that is better rendered in system memory by the CPU than in VRAM by a GPU for whatever reason. Alternate orientations refer to displays wherein the display device has been physically reoriented by ninety-, one hundred eighty-, or two hundred seventy degrees (requiring remapping of the pixels in memory to the frame buffer of the display device). Compositing of overlays is a means by which pop-ups, menus, and cursors are presented as “floating” on top of the current graphical display. Shading refers to the coloring of polygons that comprise a graphic, usually a three-dimensional graphic, and includes without limitation flat shading (assigning single colors to each polygon in a graphic), Gouraud shading (interpolating colors by averaging between the vertices of each polygon), and Phong shading (averaging each pixel based on the colors of the pixels adjacent to that pixel). Texturing refers to the process of taking a two-dimensional image and “wrapping” it around a three-dimensional object. Alpha-blending is the blending of two graphics, based on percentage weight given to each original graphic, that produces, for example, fade-in and fade-out effects.

Another complex graphic operation is anti-aliasing which smoothes the rough edges of a graphic element—caused by the naturally jagged-edge effect of using pixels to draw curves—by adjusting edge pixel locations and intensities so that there is a more gradual transition between the edge of the graphic element and the background. Sub-pixel manipulation is similar to anti-aliasing in that, where anti-aliasing works at the pixel level, sub-pixel manipulation works at the sub-pixel level where each pixel of, for example, a Liquid Crystal Display (LCD) is comprised of three subpixels: red, green, and blue. An example of a sub-pixel manipulation technology (SPMT) is Microsoft's ClearType™ technology which is disclosed in the following U.S. patents: U.S. Pat. No. 6,188,385 entitled “METHOD AND APPARATUS FOR DISPLAYING IMAGES SUCH AS TEXT”; U.S. Pat. No. 6,278,434 entitled “NON-SQUARE SCALING OF IMAGE DATA TO BE MAPPED TO PIXEL SUB-COMPONENTS”; U.S. Pat. No. 6,339,426 entitled “METHODS, APPARATUS AND DATA STRUCTURES FOR OVERSCALING OR OVERSAMPLING CHARACTER FEATURE INFORMATION IN A SYSTEM FOR RENDERING TEXT ON HORIZONTALLY STRIPED DISPLAYS”; U.S. Pat. No. 6,342,890 entitled “METHODS, APPARATUS, AND DATA STRUCTURES FOR ACCESSING SUB-PIXEL DATA HAVING LEFT SIDE BEARING INFORMATION”; U.S. Pat. No. 6,356,278 entitled “METHODS AND SYSTEMS FOR ASYMMETERIC SUPERSAMPLING RASTERIZATION OF IMAGE DATA”; and U.S. Pat. No. 6,384,839 entitled “METHOD AND APPARATUS FOR RENDERING SUB-PIXEL ANTI-ALIASED GRAPHICS ON STRIPE TOPOLOGY COLOR DISPLAYS”.

In light of these complex graphics technologies, graphics card technology has not been able to keep pace with the significant advances in complex graphics elements. Video drivers have not been sufficiently improved to take full advantage of many of these advances in graphics card technology, and GPU technology (and its lack of caching capabilities) has not kept pace with the rapid advances in CPU technology. Consequently, in view of the present invention, many of these graphics functions can be more efficiently executed by the CPU using system memory than is possible by the GPU using VRAM, and particularly complex graphics functions including without limitation shading, texturing, anti-aliasing, and alpha-blending, and sub-pixel manipulation.

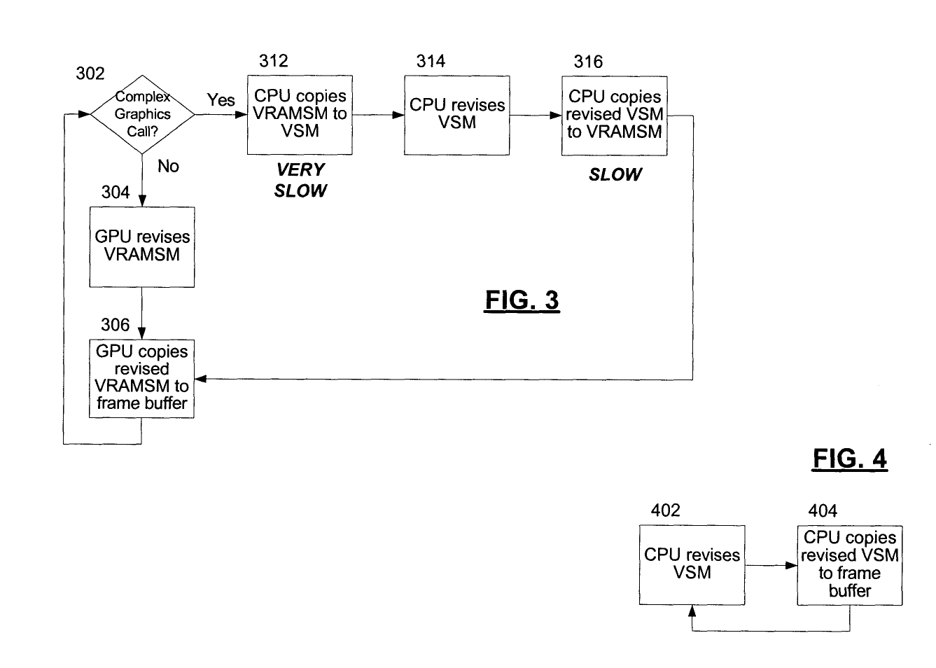

To render complex graphic elements—for example, the sub-pixel manipulation of text using ClearType™ technology—it is necessary to render the graphics in system memory with the CPU. FIG. 3 is a flowchart illustrating the approach by which simple (non-complex) graphics are rendered by the GPU and complex graphics are rendered by the CPU. Beginning at step 302, and for each graphic call recursively, the graphic processing subsystem must first determine if the graphics call requires the rendering of complex graphics (such as SPMT graphics). If not, and only simple graphics need to be rendered, at step 304 the GPU proceeds to revise the graphic in the VRAMSM and then, at step 306, the GPU copies the revised VSM to the frame buffer. On the other hand, if the graphics call does indeed require the rendering of complex graphics (which are generally beyond the capabilities of the GPU and its video driver), the CPU, at step 312, must first copy the VRAMSM to the VSM (a very slow process over the AGP which favors a system-to-video flow of data traffic). Once this is completed, the CPU may then, at step 314, revise the VSM and, at step 316, copy the revised VSM (and its complex graphics) back to the VRAMSM (which is also a relatively slow process) and the GPU, at step 306, can again copy the VRAMSM to the frame buffer.

In the case of both graphics accelerators and graphics coprocessors, and as reflected in FIG. 3, the frame buffer (or its equivalent in the VRAMSM) must be copied from the graphics card to the system memory for processing by the CPU and then copied back from the system memory to VRAM. However, because AGP favors a system-to-video flow of data traffic, copying graphics from VRAM to system memory is time consuming and resource intensive, and thereby effectively negates any gains from utilizing the GPU. Indeed, even without an AGP, systems that employ only a system bus (such as a PCI bus) also experience degraded performance because of the additional time necessary for copying the display from the graphics card to system memory.

The present invention provides a solution to these shortcomings. One embodiment of the present invention, as illustrated in FIG. 4, is the method for render graphics, and in particular complex graphics (particularly a graphic comprising shading, texturing, alpha-blending, anti-aliasing, and/or sub-pixel manipulation) wherein the GPU and VRAMSM are bypassed altogether and all graphics are rendered in the VSM, at step 402, by the CPU and copied, at step 404, directly to the frame buffer. This direct two-step method not only avoids the data flow problems inherent to computer systems that favor system-to-video flow of data traffic (that is, computer systems that employ an AGP), but it also takes advantage of modern CPUs having increased computational speeds (that are orders-of-magnitude greater than the speeds of legacy processors) such that the burden of rendering graphics in the CPU is no longer a significant resource cost such that the gains in graphics rendering more than offset any such CPU processing cost. Moreover, by rendering all graphics (complex or otherwise) in system memory by the CPU, the approach obviates the need to copy the contents of the VRAM into system memory.

### CONCLUSION

The various system, methods, and techniques described herein may be implemented with hardware or software or, where appropriate, with a combination of both. Thus, the methods and apparatus of the present invention, or certain aspects or portions thereof, may take the form of program code (i.e., instructions) embodied in tangible media, such as floppy diskettes, CD-ROMs, hard drives, or any other machine-readable storage medium, wherein, when the program code is loaded into and executed by a machine, such as a computer, the machine becomes an apparatus for practicing the invention. In the case of program code execution on programmable computers, the computer will generally include a processor, a storage medium readable by the processor (including volatile and non-volatile memory and/or storage elements), at least one input device, and at least one output device. One or more programs are preferably implemented in a high level procedural or object oriented programming language to communicate with a computer system. However, the program(s) can be implemented in assembly or machine language, if desired. In any case, the language may be a compiled or interpreted language, and combined with hardware implementations.

The methods and apparatus of the present invention may also be embodied in the form of program code that is transmitted over some transmission medium, such as over electrical wiring or cabling, through fiber optics, or via any other form of transmission, wherein, when the program code is received and loaded into and executed by a machine, such as an EPROM, a gate array, a programmable logic device (PLD), a client computer, a video recorder or the like, the machine becomes an apparatus for practicing the invention. When implemented on a general-purpose processor, the program code combines with the processor to provide a unique apparatus that operates to perform the indexing functionality of the present invention.

While the present invention has been described in connection with the preferred embodiments of the various figures, it is to be understood that other similar embodiments may be used or modifications and additions may be made to the described embodiment for performing the same function of the present invention without deviating there from. For example, while exemplary embodiments of the invention are described in the context of digital devices emulating the functionality of personal computers, one skilled in the art will recognize that the present invention is not limited to such digital devices, as described in the present application may apply to any number of existing or emerging computing devices or environments, such as a gaming console, handheld computer, portable computer, etc. whether wired or wireless, and may be applied to any number of such computing devices connected via a communications network, and interacting across the network. Furthermore, it should be emphasized that a variety of computer platforms, including handheld device operating systems and other application specific hardware/software interface systems, are herein contemplated, especially as the number of wireless networked devices continues to proliferate. Therefore, the present invention should not be limited to any single embodiment, but rather construed in breadth and scope in accordance with the appended claims.

1. A method for rendering graphics on a display device for a computer system having a central processing unit, system random access memory, and a graphics card, said graphics card comprising a graphical processing unit, video random access memory, and a frame buffer, said method comprising:
rendering a graphic in the system random access memory with the central processing unit; and
copying said graphic from the system random access memory to the frame buffer.

2. The method of claim 1 wherein said graphic comprises a complex graphic element.

3. The method of claim 2 wherein said complex graphic comprises a sub-pixel manipulation technology.

4. The method of claim 2 wherein said complex graphic comprises anti-aliasing.

5. The method of claim 2 wherein said complex graphic comprises shading.

6. The method of claim 2 wherein said complex graphic comprises texturing.

7. The method of claim 2 wherein said complex graphic comprises alpha-blending.

8. The method of claim 2 wherein said portrait-oriented graphic is displayed on the display device in a secondary portrait mode.

9. The method of claim 2 wherein said complex graphic comprises a compositing of overlays.

10. The method of claim 1 wherein said computer system further comprises an accelerated graphics port (ACP) between the central processing unit, the system random access memory, and the graphics card.

11. The method of claim 1 wherein said graphic card comprises a graphics accelerator.

12. The method of claim 1 wherein said graphic card comprises a graphics coprocessor.

13. A computer-readable medium having computer-readable instructions for rendering graphics on a display device for a computer system comprising a central processing unit, system random access memory, and a graphics card, said graphics card comprising a graphical processing unit, video random access memory, and a frame buffer, said computer-readable instructions comprising:
instructions for rendering said graphic in the system random access memory with the central processing unit; and
instructions for copying said graphic from the system random access memory to the frame buffer.

14. The computer-readable medium of claim 13 further comprising instructions for rendering a complex graphic in system random access memory with the central processing unit.

15. The computer-readable medium of claim 14 wherein said complex graphic comprises a sub-pixel manipulation technology.

16. The computer-readable medium of claim 14 wherein said complex graphic comprises anti-aliasing.

17. The computer-readable medium of claim 14 wherein said complex graphic comprises shading.

18. The computer-readable medium of claim 14 wherein said complex graphic comprises texturing.

19. The computer-readable medium of claim 14 wherein said complex graphic comprises alpha-blending.

20. The computer-readable medium of claim 14 wherein said complex graphic comprises an orientation-change graphic.

21. The computer-readable medium of claim 14 wherein said complex graphic comprises a compositing of overlays.

22. A system for rendering graphics on a display device, said system comprising:
a central processing unit;
system random access memory coupled to said central processing unit;
a graphics card coupled to said central processing unit and system random access memory, said graphics card comprising a graphical processing unit, video random access memory, and a frame buffer; and
a software program, loaded into system random access memory, for the central processing unit to render said graphics in the system random access memory and to copy said graphics from the system random access memory to the frame buffer.

23. The system of claim 22 wherein said graphics comprise a complex graphic element.

24. The system of claim 23 wherein said complex graphic comprises a sub-pixel manipulation technology.

25. The system of claim 22 wherein said computer system further comprises an accelerated graphics port (ACP) coupled to the central processing unit, the system random access memory, and the graphics card.

26. The system of claim 22 wherein said graphic card comprises a graphics accelerator.

27. The system of claim 22 wherein said graphic card comprises a graphics coprocessor.

28. A system for rendering graphics on a display device for a computer system having a central processing unit, system random access memory, and a graphics card, said graphics card comprising a graphical processing unit, video random access memory, and a frame buffer, said method comprising:
means for rendering said graphic in the system random access memory with the central processing unit; and
means for copying said graphic from the system random access memory to the frame buffer.
